(19) United States
(12) Patent Application Publication
(10) Pub. No.: US 2015/0096265 A1
(43) Pub. Date: Apr. 9, 2015

(54) Apparatus for Automatically Adhering Seeds to Biodegradable Mulching Film Having Anti-Blocking Function and Method for Adhering Seeds by Using Same

(71) Applicant: Ock KWON, (US)

(72) Inventor: Young Hoon Choe, Chungcheongbuk-do (KR)

(73) Assignee: Ock Kwon, Gyeonggi-do (KR)

(21) Appl. No.: 14/401,146

(22) PCT Filed: Jan. 21, 2013
(86) PCT No.: PCT/KR2013/000451

§ 371 Date: Nov. 14, 2014

(30) Foreign Application Priority Data
May 18, 2012 (KR) 10-2012-0053263

(51) Int. Cl. A01C 1/04

(52) U.S. Cl. CPC A01C 1/042; A01C 2001/048
USPC 53/450; 53/545

(57) ABSTRACT

The present invention relates to an apparatus for automatically adhering seeds (hereinafter “seeds” shall refer to pre-germination seed rice when adhered to the mulching film, and to seeds which have germinated and divided after being planted and growing deeper roots in a rice paddy) to a biodegradable mulching film having an anti-blocking function, and to a method for adhering the seeds by using the apparatus. More specifically, the present invention relates to the apparatus for automatically adhering the seeds, which forms by means of a cutting means or a punching means through-holes or germination gaps on the mulching film on which germination holes have not been punched, can process adhesive coating and seed adhering in an accurate, swift, and automatic manner, and which is provided with a releasing agent so as to coat the releasing agent after coating the adhesive, thereby preventing blocking due to overlapping of the mulching film when winding same.

### CROSS-REFERENCE TO RELATED APPLICATIONS

This is a US national phase of PCT patent Application No. PCT/KR2013/000451 having an International filing date of Jan. 21, 2013, which claims priority to Korean Patent Application No. 10-2012-0053263, filed on May 18, 2012, the entireties of which are incorporated herein by reference.

### FIELD OF THE INVENTION

The present invention relates to an apparatus for automatically adhering seeds (hereinafter “seeds” shall refer to pre-germination rice seed when adhered to a mulching film, and to seeds which have germinated and divided after being planted and taking root in a rice paddy) to a biodegradable mulching film having an anti-blocking function, and to a method for adhering the seeds by using the apparatus. More specifically, the present invention relates to an apparatus for automatically adhering seeds, which may form, by means of a cutting unit or a punching unit, through holes or germination gaps on a mulching film where germination holes have not been punched and may accurately, quickly and automatically process an adhesive coating and a seed adhering and may prevent any blocking between mulching films when winding by coating a release agent after an adhesive is coated by using a release agent coating unit.

### BACKGROUND OF THE INVENTION

In general, an agricultural method for rice cultivation is characterized in that rice seeds are directly planted on a rice paddy by a direct planting method or seedlings were raised and then transplanted them into the rice paddy. In case of the direct planting method, there will have some problems like that the rice could be damaged by birds or it needs to spray herbicide. In case of that seedlings were raised and then transplanted them into the rice paddy, work for raising seedlings and transplanting are necessary, which would result in complicated procedures and prolonged working time while also requiring a herbicide spraying work.

In addition, when even performing a seed-based agriculture using a biologically degradable and environment-friendly mulching film so as to prevent weeds without using any herbicide by improving the typical agricultural method, a process for accurately forming through holes at regular intervals on a mulching film is hard, and there is not any device for forming holes on a mulching film while keeping regular intervals and for simultaneously coating an adhesive and adhering seeds, so the above-mentioned method may not be effectively performed.

In addition, when germination holes (through holes) are formed on a typical mulching film, damages due to birds are also present, and weeds and seeds may germinate together through the through holes, and it is hard to maintain proper germination temperature and humidity.

Also, a series of adhesive adhering process and seed adhering process may be not efficiently performed due to the automated process, the manufacturing takes a long time, and the manufacturing cost will increase also.

When the through holes are formed on the mulching film, the adhesive is coated, and the seed are adhered, and the seed-adhered mulching film is wound around a re-winder, there may occur a blocking phenomenon where the gaps between the mulching films are adhered to each other by means of the adhesive remaining on the mulching film. Therefore, when the blocking phenomenon occurs, there would be a problem that it becomes hard to properly lay the mulching film over the soil of the rice paddy.

In the above case, it further needs a step for drying the adhesive using an additionally provided drier before the mulching film is wound around the re-winder so as to prevent the above-mentioned blocking phenomenon, which would result in added cost and prolonged time. In the above case, there is another problem that it is hard to additionally input fertilizer after the seeds are covered under the mulching film.

Therefore, it needs to develop an automated apparatus and method which make it possible to quickly, accurately and automatically process the adhesive coating process and seed adhering process and to prevent the blocking phenomenon of the mulching film without any adhesive drying process.

### BRIEF DESCRIPTION OF DRAWINGS

FIG. 1 is a partial front view illustrating a mulching film which is inputted in a seed adhering automation device having a blocking prevention function according to an exemplary embodiment of the present invention.

FIG. 2 is a partial front view illustrating a mulching film to which an identifier is adhered, which is inputted in a seed adhering automation device having a blocking prevention function according to an exemplary embodiment of the present invention.

FIG. 3 is a flow chart of a seed adhering method using a seed adhering automation device having a blocking prevention function according to an exemplary embodiment of the present invention.

FIG. 4 is a cross sectional view schematically illustrating a seed adhering automation device having a blocking prevention function according to an exemplary embodiment of the present invention.

FIG. 5 is a partial front view illustrating a mulching film on which a plurality of germination gaps are formed according to an exemplary embodiment of the present invention.

FIG. 6 is a partial front view illustrating a mulching film on which a plurality of germination gaps are formed, wherein an identifier is adhered to each of the germination gaps according to an exemplary embodiment of the present invention.

FIG. 7 is a cross sectional view illustrating a re-winder around which a mulching film is wound, wherein a typical release agent is not coated on the mulching film.

FIG. 8 is a cross sectional view illustrating a rewinder around which a mulching film is wound, wherein a release agent is coated on the mulching film according to an exemplary embodiment of the present invention.

FIG. 9 is a block diagram illustrating a seed adhering automation device having a blocking prevention function, while illustrating a signal flow by means of a controller according to an exemplary embodiment of the present invention.

### DETAILED DESCRIPTION OF THE INVENTION

The present invention is made in an effort to improve the above mentioned problems. According to an exemplary embodiment of the present invention, it is an object of the present invention to provide an automated apparatus for eliminating the blocking phenomenon of the mulching films by continuously coating a release agent on a portion where an adhesive is coated after the adhesive is coated and seeds are adhered by providing a release agent coating unit. In addition, the present invention provides an automated apparatus wherein it does not need to add fertilizer after a mulching film is laid since the release agent is formed of fertilizer.

The present invention provides an apparatus and method for automatically adhering seeds which are characterized in that a plurality of germination gaps are formed by means of a cutting unit instead of the typical germination holes (through hole) for thereby preventing damages, by birds the germination of weeds and more efficiently maintaining germination temperature and humidity.

According to an exemplary embodiment of the present invention, there are provided an apparatus and method for quickly, accurately and automatically adhering seeds to a predetermined portion by providing a cutting unit which includes a plurality of cutter knifes or laser beam emitting units which are spaced-apart by predetermined intervals, an adhesive coating unit having a plurality of nozzles, a seed adhering unit having a plurality of adhering arms, and a release agent coating unit.

Also, the present invention provides an apparatus and method for manufacturing a mulching film on which seeds are adhered at various intervals by automatically forming germination gaps or through holes by recognizing a portion where seed are adhered in such a way that without any human labor in the course of the processing procedure, the adhesive coating unit, the seed adhering unit and the release agent coating unit are configured to recognize identifiers adhered to the mulching film, and such an apparatus and method make it possible to perform the processes of coating an adhesive, adhering seeds and coating a release agent and also make it possible to perform the processes of coating an adhesive, adhering seeds and coating a release agent by forming germination holes or through holes at specifically set intervals on the mulching film by providing an interval adjusting unit.

Other purposes, specific advantages and new features of the present invention will become apparent from the following detailed descriptions and exemplary embodiments of the present invention in relation to the accompanying drawings.

To achieve the above objects, there is provided an apparatus for automatically adhering seeds to a mulching film which includes an unwinder which is configured to wind the mulching film and store in a roll shape; a moving means which is configured to move the mulching film wound around the unwinder to a work space; a punching means which is provided at the work space and forms a plurality of through holes each having a predetermined diameter, on the mulching film which has been moved to the work space or a cutting means which forms a plurality of germination gaps each having a predetermined length, on the mulching film; an adhesive coating means which is provided at the work space and coats an adhesive on the mulching film which has the germination gaps; a seed adhering means which is configured to adhere the seeds to a portion where the adhesive is coated by the adhesive coating means; a release agent coating means which is configured to coat a release agent on the seed-adhered mulching film for thereby eliminating an adhering force of the adhesive; a rewinder which is configured to wind the seed-adhered mulching film and store in a roll shape; and a controller which is configured to control the unwinder, the moving means, the cutting means, the adhesive coating means, the seed adhering means, the release agent coating means and the rewinder.

The identifiers spaced apart at a first specific interval in a longitudinal direction are adhered to the mulching film wound around the unwinder, and the identifiers are recognized by a first detection unit provided at the cutting means or the punching means, a second detection unit provided at the adhesive coating means, a recognition unit provided at the seed adhering means and a third detection unit provided at the release agent coating means, and the detection signal is transmitted to the controller, and the controller adjusts a moving speed and a tension of the mulching film by controlling the moving means, and the cutting means or the punching means includes a plurality of cutter knifes and a plurality of laser beam emitting means which are spaced apart at a second specific interval, and a first interval adjusting unit for adjusting the second specific interval, and the adhesive coating means includes a storing unit for storing an adhesive, a plurality of nozzles which are spaced apart at the second specific interval and are configured to spray the adhesive onto the portions where the germination gaps or the through holes are formed, an input unit for supplying the adhesive from the storing unit to the nozzles, and a second interval adjusting unit for adjusting the intervals between the nozzles, and the seed adhering means includes a seed storing unit for storing seeds, a plurality of adhering arms which are spaced apart at a second specific interval and are configured to adhere the seeds to the portions where the adhesive is coated, and a third interval adjusting unit for adjusting the interval between the adhering arms, and the release agent coating means includes a release agent storing unit for storing the release agent, a plurality of release agent nozzles which are spaced apart at the second specific interval and are configured to spray the release agent onto the portions where the adhesive is coated, a release agent input unit for supplying the release agent from the release agent storing unit to the release agent nozzles, and a fourth interval adjusting unit for adjusting the interval between the release agent nozzles.

The controller stops the driving of the moving means when receiving a detection signal on the identifier detected by the first detection unit and cuts the mulching film by operating and controlling the cutting means, and a plurality of germination gaps spaced apart at a second specific interval are formed on the mulching film in the widthwise direction, and when the detection signal on the identifier detected by the second detection unit is received, the controller stops the driving of the moving means and inputs a predetermined set amount of the adhesive into the nozzles by operating and controlling the input unit and controls the adhesive to be sprayed onto the portions around which the germination gaps are formed by operating and controlling the nozzles, and when the recognition unit receives the detection signal on the identifier, the controller stops the driving of the moving means and adheres the seeds to the portions where the adhesive is coated by controlling the adhering arms.

As another category of the present invention, to achieve the above objects, there is provided a method for adhering seeds by using the apparatus for automatically adhering seeds to a biodegradable mulching film having an anti-blocking function, which includes a step where a mulching film is wound around an unwinder and is stored in a roll shape; a step where the mulching film wound around the unwinder is moved by a moving means to a work space; a step where a plurality of germination gaps are formed using a cutting means on the mulching film which has been moved to the work space or a plurality of through holes are formed using a punching means on the mulching film; a step where an adhesive is coated, using the nozzles of the adhesive coating means, on the portions where the germination gaps or the through holes are formed; a step where the seeds are adhered, using adhering arms of the seed adhering means, to the portions where the adhesive is coated; a step where a release agent is coated, using release agent nozzles provided at the release agent coating means, on the portions where the adhesive is coated; and a step where the seed-adhered mulching film is wound using the rewinder and is stored in a roll shape.

The identifiers spaced apart at first specific intervals in longitudinal directions are adhered to the mulching film, and the forming step includes a step where a first detection unit provided at the cutting means or the punching means detects the identifiers, and the detection signal is transmitted to the controller, and the adhesive coating step includes a step where a second detection unit provided at the adhesive coating means detects the identifiers, and the detection signal is transmitted to the controller, and the seed adhering step includes a step where a recognition unit provided at the seed adhering unit recognizes the identifiers, and the recognized signal is transmitted to the controller, and the release agent coating step includes a step where a third detection unit provided at the release agent coating means detects the identifiers, and the detection signal is transmitted to the controller.

Before the moving step, there is further provided a step where a first interval adjusting unit provided at the cutting means or the punching means adjusts the intervals between a plurality of cutting knifes or a plurality of laser beam emitting means provided at the cutting means or the punching means to the second specific interval, and a second interval adjusting unit provided at the adhesive coating means adjusts the interval between a plurality of nozzles provided at the adhesive coating means, and a third interval adjusting unit provided at the seed adhering means adjusts the interval between a plurality of adhering arms provided at the seed adhering means to the second specific interval, and a third interval adjusting unit provided at the release agent coating means adjusts the interval of a plurality of release agent nozzles provided at the release agent coating means to the second specific interval, and the germination gap forming step includes a step where when the detection signal on the identifiers detected by the first detection unit is received, the controller stops the driving of the moving means and forms a plurality of germination gaps or a plurality of through holes which are spaced apart at the second specific interval in the widthwise direction of the mulching film by operating and controlling the cutter knifes or laser beam emitting means provided at the cutting means or the punching means, and the adhesive coating step further includes a step where when the detection signal on the identifiers detected by the second detection unit, the controller stops the driving of the moving means and controls for a predetermined set amount of the adhesive to be inputted into the nozzles by operating and controlling the input unit provided at the adhesive coating means and controls for the adhesive to be sprayed onto the portions where the germination gaps are formed by operating and controlling the nozzles, and the seed adhering step further includes a step where when the recognition unit receives the detection signal on the identifiers, the controller stops the driving of the moving means and controls the seeds to be adhered to the portions where the adhesive is coated, by controlling the adhering arms, and the release agent coating step further includes a step where when the detection signal on the identifiers detected by the third detection unit is received, the controller controls for a predetermined set amount of release agent to be inputted into the release agent nozzles by operating and controlling the release agent input unit provided at the release agent coating means, and controls for the release agent to be sprayed onto the portions where the adhesive is coated, by operating and controlling the release agent nozzles.

### ADVANTAGEOUS EFFECTS

Therefore, according to the exemplary embodiment of the present invention, the present invention has an effect of preventing a blocking phenomenon of the mulching films by continuously coating a release agent on a portion where the adhesive is coated after the adhesive is coated and the seeds are adhered, by providing a release agent coating unit. Also, the adhesive agent drying step which used to be performed in the typical seed film automation step is eliminated, so labor for inputting fertilizer may be saved by inputting fertilizer and seeds which are necessary for the growth of crop while enhancing productivity.

Also, a plurality of germination gaps instead of the typical germination holes (through holes) are formed by means of the cutting unit, so that the present invention can have an effect in the way that any damages by birds may be prevented, and the germination of weed may also be prevented, and the germination temperature and humidity may be more efficiently maintained.

The exemplary embodiment of the present invention has an advantage in the way that it is possible to quickly, accurately and automatically adhere seeds to a predetermined portion by providing a cutting unit which includes a plurality of cutter knifes or laser beam emitting units which are spaced-apart by predetermined intervals, an adhesive coating unit having a plurality of nozzles, a seed adhering unit having a plurality of adhering arms, and a release agent coating unit.

Also, the present invention has an effect of manufacturing a mulching film on which seeds are adhered at various intervals by automatically forming germination gaps or through holes by recognizing a portion where seed are adhered in such a way that without any human labor in the course of the processing procedure, the adhesive coating unit, the seed adhering unit and the release agent coating unit are configured to recognize identifiers adhered to the mulching film, and such an apparatus and method make it possible to perform the processes of coating an adhesive, adhering seeds and coating a release agent and also make it possible to perform the processes of coating an adhesive, adhering seeds and coating a release agent by forming germination holes or through holes at specifically set intervals on the mulching film by providing an interval adjusting unit.

Although the present invention has been described in relation to the above-mentioned exemplary embodiment, however it is obvious that a person having ordinary skill in the art can easily recognize that various modification and amendments may be possible without departing from the concept and scope of the present invention, and such modification and amendment belong to the scope of the attached claims.

### MODE FOR INVENTION

The exemplary embodiments of the present invention which a person having ordinary skill in the art can easily implement will be described with reference to the accompanying drawings, provided that if it is judged that the detailed description on the related function or configuration may make unclear the concept of the invention while describing in detail the operational principle with respect to the exemplary embodiment of the present invention, the description thereof might be omitted.

In addition, the components having the similar functions and operations might be given the same reference numbers over the specification. In the course of the descriptions of the specification, what a predetermined component is described as being connected to any component means that the predetermined component may be directly connected thereto or it may be indirectly connected thereto through another predetermined component disposed between them. In addition, what a predetermined component is included means that unless otherwise stated means that another component may be further included not excluding any other component.

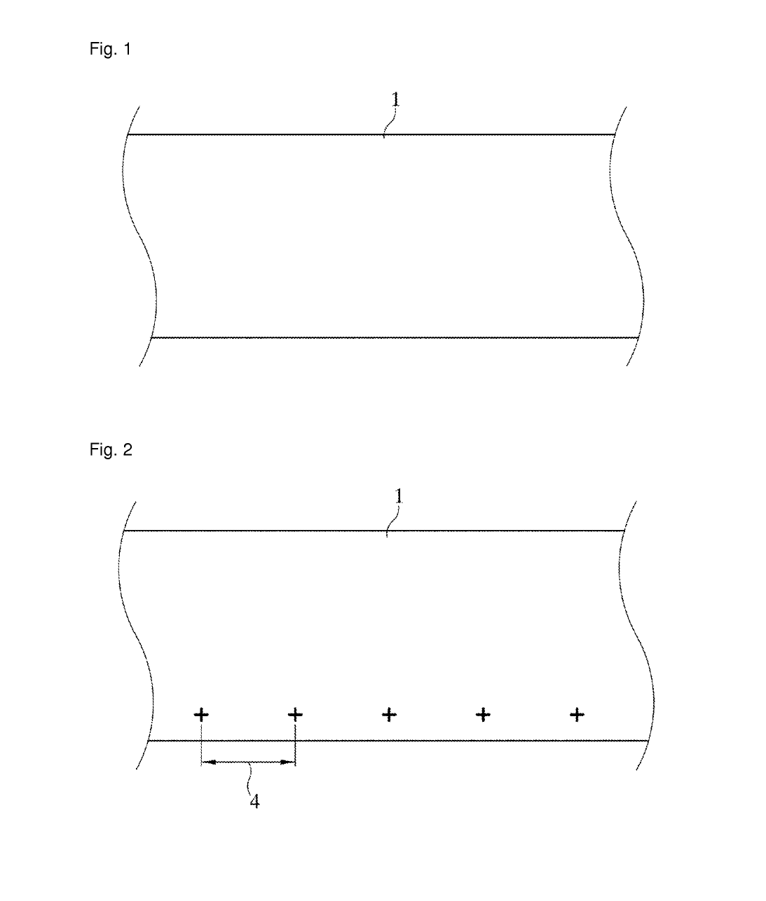

The configuration and operation of the seed adhering automation device 100 having a blocking prevention function so as to adhere seeds to a biodegradable mulching film 1 according to an exemplary embodiment of the present invention. First, FIG. 1 is a partial front view illustrating a mulching film 1 which is an object to which seeds are adhered by means of the seed adhering automation device 100 having a blocking prevention function according to an exemplary embodiment of the present invention.

Referring to FIG. 1, the biodegradable mulching film 1 inputted into the seed adhering automation device 100 having a blocking prevention function according to an exemplary embodiment of the present invention does not include a plurality of germination holes.

In addition, FIG. 2 is a partial front view illustrating a mulching film 1 wherein an identifier 6 is adhered to the mulching film 1 which is an object to which seeds are adhered by means of the seed adhering automation device 100 having a blocking prevention function according to an exemplary embodiment of the present invention. Referring to FIG. 2, the identifier 6 is adhered to the biodegradable mulching film 1 inputted in the seed adhering automation device 100 having a blocking prevention function according to an exemplary embodiment of the present invention. The identifiers 6, as illustrated in FIG. 2, are adhered to the lower side of the mulching film 1 at first specific intervals 4 in longitudinal directions. Since the identifiers 6 are adhered in the above-mentioned manner, the identifiers 6 may be recognized by means of a cutting unit 30 or a punching unit, an adhesive coating unit 40, a seed adhering unit 50 and a release agent unit 60 which are all provided at the seed adhering automation device 100 having a blocking prevention function according to an exemplary embodiment of the present invention, so that the germination gaps 3 may be accurately formed, the adhesive may be coated, and the seeds may be adhered, and then the release agent may be coated.

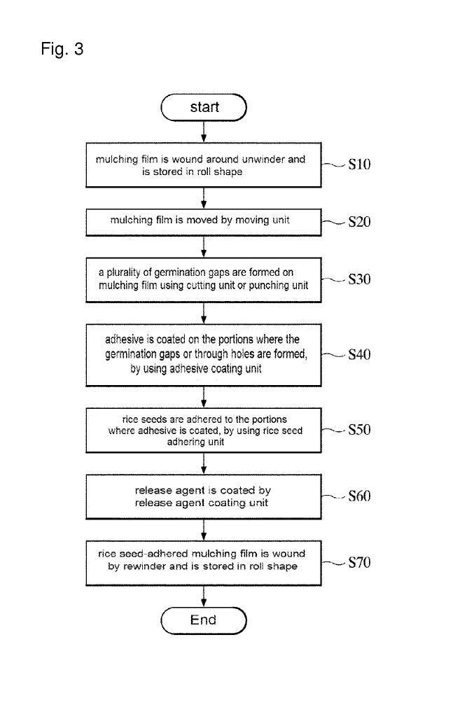

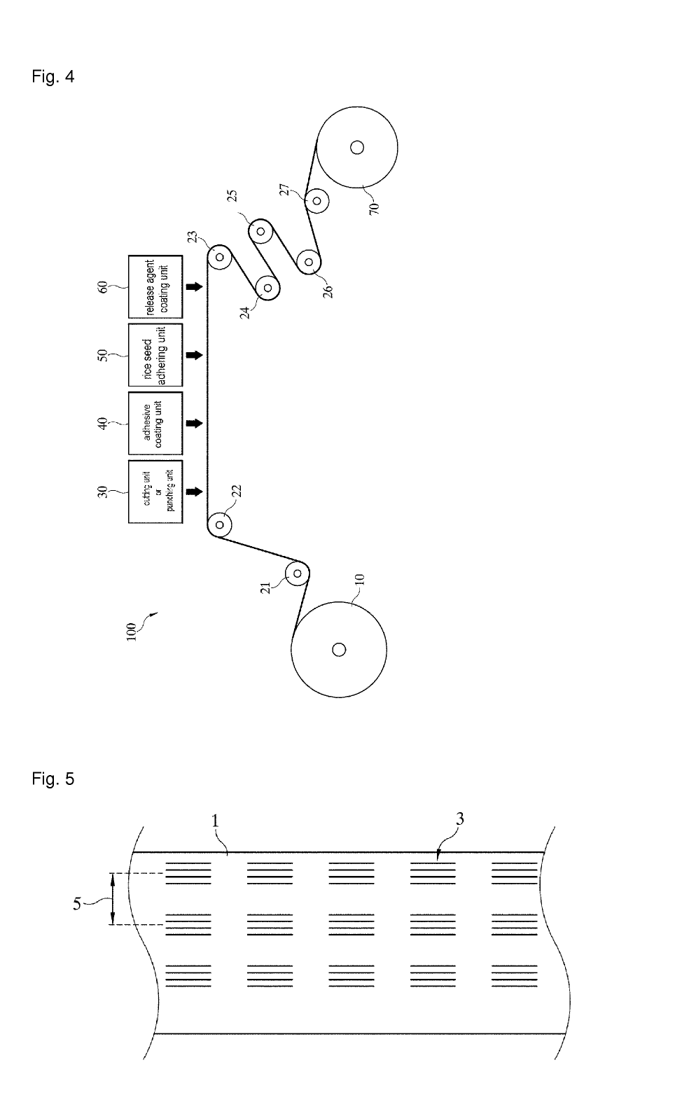

FIG. 3 is a flow chart of a seed adhering method using a seed adhering automation device 100 having a blocking prevention function according to an exemplary embodiment of the present invention. FIG. 4 is a cross sectional view schematically illustrating a seed adhering automation device 100 having a blocking prevention function according to an exemplary embodiment of the present invention.

Referring to FIGS. 3 and 4, the seed adhering automation device 100 having a blocking prevention function according to an exemplary embodiment of the present invention is an automated device 100 for adhering seeds to the aforementioned mulching film 1 and includes an unwinder 10 configured to wind the mulching film 1 and store in a roll shape, a moving unit 20 configured to move the mulching film 1 wound around the unwinder 10 to a work space, a cutting unit 30 configured to form a plurality of germination holes on the mulching film 6 by detecting the identifier 6 with the aid of a first detection unit 31, an adhesive coating unit 40 configured to coat an adhesive on the mulching film 1, which has been moved into the work space, by providing a second detection unit 42 configured to detect the identifier 6, a seed adhering unit 50 configured to adhere the seeds to the portion on which the adhesive is coated by the adhesive coating unit 40 by providing a recognition unit 52 configured to recognize the identifier 6, a release agent coating unit configured to coat a release agent on the portion where the adhesive has been coated in the mulching film 1 by providing a third detection unit 63 configured to recognize the identifier 6, and a rewinder 70 configured to wind the mulching film 1 to which the seeds are adhered and to store the seed-adhered mulching film 1 in a roll shape.

The seed adhering automation device 100 according to an exemplary embodiment of the present invention includes a controller 80 for adjusting the moving speed and tension of the mulching film 1 by controlling the unwinder 10, the moving unit 20 and the rewinder 70. In addition, the controller 80, which will be described later in more detail, controls the cutting unit 30 and the adhesive coating unit 40 to accurately form the germination gaps 3 at predetermined portions while controlling the adhesive to be coated, and controls the seed adhering unit 50 for the seeds to be accurately adhered to predetermined portions and controls the release agent coating unit 70 for the release agent to be coated on predetermined portions.

The method for adhering seeds using the seed adhering automation device 100 having a blocking prevention function according to an exemplary embodiment of the present invention is characterized in that the biodegradable mulching film 1 on which the identifiers 6 are provided is wound around the unwinder 10 and is stored in a roll shape (S10).

In addition, the controller 80 moves the mulching film 1 wound around the unwinder 10 into the work space by controlling and driving the moving unit 20 (S20). Referring to FIG. 4, the moving unit 20 according to an exemplary embodiment of the present invention includes a first rotation unit 21, a second rotation unit 22, a third rotation unit 23, a fourth rotation unit 24, a fifth rotation unit 25, a sixth rotation unit 26, and a seventh rotation unit 27.

Therefore, the controller 80 controls the moving speed of the mulching film 1 and the tension of the mulching film 1 by controlling the driving speed of each of the first rotation unit 21, the second rotation unit 22, the third rotation unit 23, the fourth rotation unit 24, the fifth rotation unit 25, the sixth rotation unit 26, and the seventh rotation unit 27.

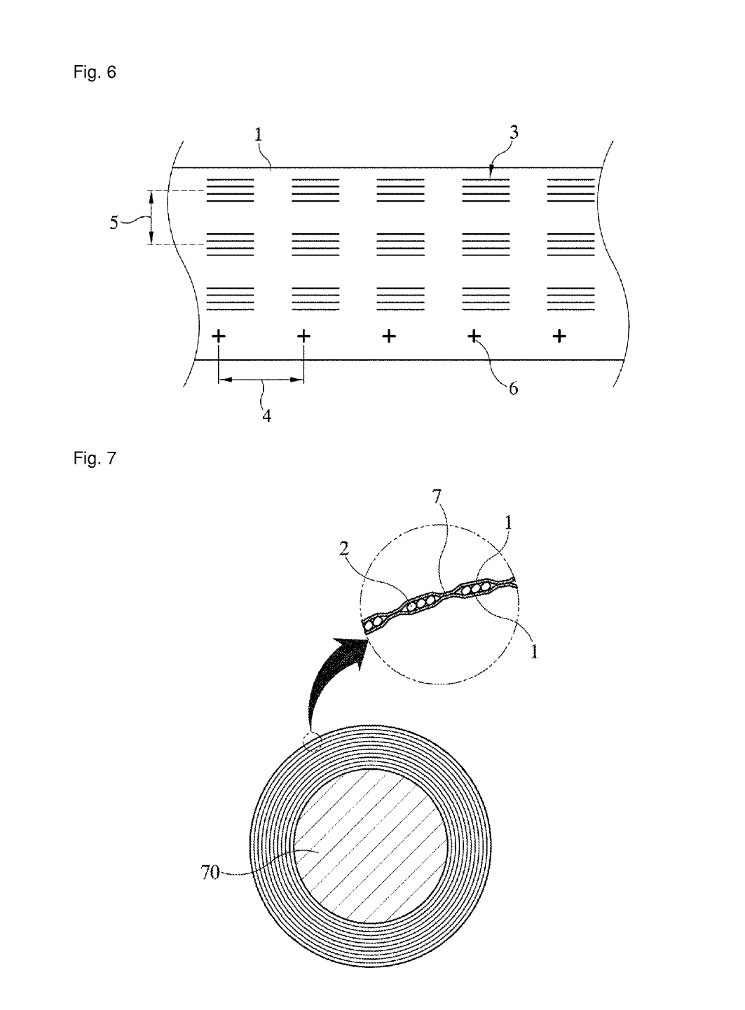

In addition, the first detection unit 31 of the cutting unit 30 detects the identifier 6 adhered to the mulching film 1 which has been moved into the work space, and a plurality of germination gaps 3 are formed on the mulching film 1 (S30). FIG. 5 is a partial front view illustrating a mulching film on which a plurality of germination gaps are formed according to an exemplary embodiment of the present invention. FIG. 6 is a partial front view illustrating a mulching film on which a plurality of germination gaps are formed, wherein an identifier is adhered to each of the germination gaps according to an exemplary embodiment of the present invention.

Referring to FIG. 6, since the cutting unit 30 includes the first detection unit 31, the identifier 6 of the mulching film can be recognized, and a plurality of the germination gaps 3 may be formed since second specific intervals 5 are spaced-apart in the widthwise direction. In the more specific embodiment, the cutting unit 30 may be formed of a plurality of cutter knifes or laser beam emitting units wherein the second specific intervals 5 are spaced apart.

In addition, the second detection unit 42 of the adhesive coating unit 40 recognizes the identifier 6 adhered to the mulching film 1 which has been moved into the work space, and the adhesive may be coated on the portions where the germination gap 3 of the mulching film 1 are formed (S 40 ). Namely, the second detection unit 42 recognizes the identifier 6 adhered to the moved mulching film 1 and transmits the detection signal to the controller 80. The controller 80 which has detected the detection signal stops the driving of the moving unit 20 and drives the adhesive coating unit 40 so as to coat the adhesive on the portions where the germination gaps 3 of the mulching film 1 are formed. In the more specific embodiment, the adhesive uses a NON VOC.

In addition, the recognition unit 52 of the seed adhering unit 50 recognizes the identifier 6 of the mulching film 1 on which an adhesive is coated, and the seeds are adhered to the portions where the adhesive is coated (S50). Namely, the recognition unit 52 recognizes the identifier 6 adhered to the mulching film 1 on which the adhesive is coated, and transmits the detection signal to the controller 80. The controller 80 which has detected the detection signal stops the driving of the moving unit 20 and drives the seed adhering unit 50, and the seeds are adhered to the portions where the adhesive of the mulching film 1 has been coated.

In addition, the third detection unit 63 of the release agent coating unit 60 recognizes the identifier 6 adhered to the mulching film 1, and the release agent is coated on the portion where the adhesive has been coated in the mulching film 1 (S60). Namely, the third detection unit 63 recognizes the identifier 6 adhered to the moved mulching film 1 and transmits the detection signal to the controller 80. The controller 80, which has detected the detection signal, stops the driving of the moving unit 20 and drives the release agent coating unit 60, so the release agent is coated on the portion where the adhesive of the mulching film 1 has been coated. Here, the release agent is not limited as far as it is a substance which has a releasing property such as liquid or powder type fertilizer, agricultural pesticides, fibroid material or minerals. The specific components of the release agent shall not affect the scope of the present invention.

Therefore, it is possible to prevent a phenomenon (blocking) where the mulching films adhere to each other later due to the bad drying when winding later the mulching film using the rewinder because the release agent coating process is performed.

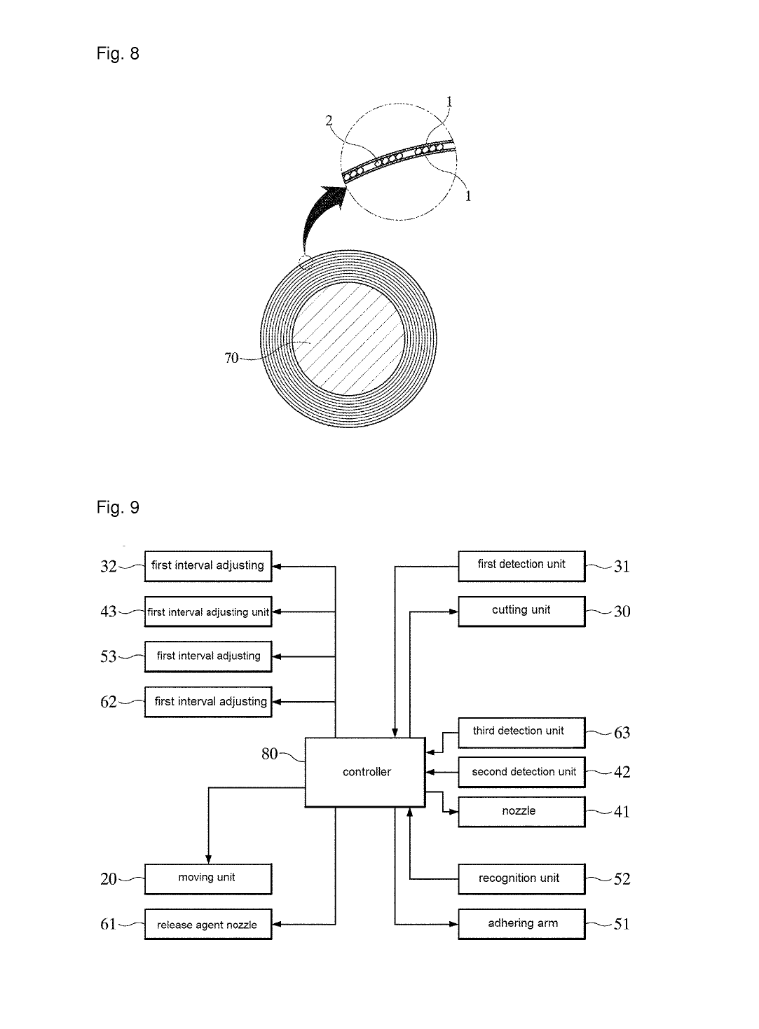

FIG. 7 is a cross sectional view illustrating a rewinder around which a mulching film is wound, wherein a typical release agent is not coated on the mulching film. FIG. 8 is a cross sectional view illustrating a re-winder around which a mulching film is wound, wherein a release agent is coated on the mulching film according to an exemplary embodiment of the present invention. Referring to FIG. 7, in case that the release agent is not coated on the mulching film 1, the mulching film wound around the rewinder 7 may be adhered to each other by the remaining adhesive. However, in case that the release agent is coated using the release agent coating unit 60 after the seeds are adhered according to an exemplary embodiment of the present invention, as illustrated in FIG. 8, the blocking phenomenon does not occur. Finally, the mulching film 1 to which the seeds are adhered using the rewinder 70 may be wound and stored in the roll shape (S70).

Also, FIG. 9 is a block diagram illustrating a seed adhering automation device 100 having a blocking prevention function, while illustrating a signal flow by means of a controller 80 according to an exemplary embodiment of the present invention. The seed adhering automation device 100 having a blocking prevention function according to an exemplary embodiment of the present invention includes an unwinder rotation unit configured to rotate the unwinder 10 wherein the biodegradable mulching film 1 on which the identifiers 6 are provided is wound and stored in the roll shape, the first rotation unit 21, the second rotation unit 22, the third rotation unit 23, the fourth rotation unit 24, the fifth rotation unit 25, the sixth rotation unit 26 and the rewinder rotation unit for rotating the rewinder 70.

The controller 80 unrolls and moves the mulching film 1 by driving the unwinder rotation unit, the first rotation unit 21, the second rotation unit 22, the third rotation unit 23, the fourth rotation unit 24, the fifth rotation unit 25, the sixth rotation unit 26 and the rewinder rotation unit. The controller 80 adjusts the moving speed of the mulching film 1 and the tension of the mulching film 1 by controlling the unwinder rotation unit, the first rotation unit 21, the second rotation unit 22, the third rotation unit 23, the fourth rotation unit 24, the fifth rotation unit 25, the sixth rotation unit 26 and the rewinder rotation unit.

The mulching film 1 moves into the work space by the operation of the first rotation unit 21 and moves through the second rotation unit 22 to the cutting unit 30. The first detection unit 31 of the cutting unit 30 recognizes the identifier 6 adhered to the mulching film and transmits the detection signal to the controller 80. The controller 80 forms a plurality of the germination gaps 3 on the mulching film 1 with the aid of a plurality of the cutter knifes or the laser beam emitting units by controlling the operation of the cutting unit 30. In addition, the cutting unit 30 includes a first interval adjusting unit 32 for thereby adjusting the interval between the cutter knifes or the laser beam emitting units.

The mulching film on which the germination gaps 3 are formed moves to a germination adhesive coating unit 40. The adhesive coating unit 40 includes a second detection unit 42 configured to recognize the identifier 6 adhered to the mulching film 1 and transmit the detection signal to the controller 80, a storing unit which stores the adhesive, a plurality of nozzles 41 which are spaced apart at second specific intervals 5 and are configured to spray the adhesive stored in the storing unit onto the mulching film 1, and an input unit disposed between the nozzles 41 and the storing unit for adjusting the amount of the adhesive which is supplied to the nozzles 41.

In addition, the adhesive coating unit 40 includes a second interval adjusting unit 43 for thereby adjusting the interval between the nozzles 31. Namely, it is possible to adjust, using the second interval adjusting unit 43, the interval between the nozzles 43 so that the interval between the nozzles 41 becomes same as the second specific interval 5 of the mulching film 1.

In addition, the amount of the adhesive supplied to the nozzles 41 may be adjusted by controlling the input unit. When the second detection unit 42 recognizes the identifier 6 while the mulching film 1 moves by the operation of the moving unit 20, the controller 80, which has received the detection signal, stops the driving of the moving unit 20, and the adhesive is supplied to the nozzles 41 by controlling the input unit, and the adhesive may be accurately and quickly coated on the portion where the germination gaps 3 are formed, by driving the nozzles 41. When the coating is finished, the controller 80 stops the driving of the nozzles 41 and moves the mulching film 1 until the second detection unit 42 recognizes the identifier 6 adhered to the next row by driving the moving unit 20.

The mulching film 1 on which the adhesive is coated by the adhesive coating unit 40 moves to the seed adhering unit 50. The seed adhering unit 50 includes a recognition unit 52 for recognizing the identifier 6 adhered to the biodegradable mulching film 1, a seed storing unit for storing seeds, a plurality of adhering arms 51 for adhering the seeds to the mulching film 1, and a seed supply unit for supplying the seeds to the adhering arm 51.

In addition, the seed adhering unit 50 may include a third interval adjusting unit 53 for adjusting the interval between the adhering arms 51. The interval between the adhering arms 51 may be adjusted so that the interval between the adhering arms 51 may be same as the second specific interval 5 of the mulching film 1 by means of the third interval adjusting unit 53.

In addition, the controller 80 controls the amount of the seeds supplied to the adhering arms 51 by controlling the seed input unit. When the recognition unit 52 recognizes the identifier 6 while the mulching film 1 moves by the operation of the moving unit 20, the controller 80, which has received the recognition signal, stops the driving of the moving unit 20, and the seeds are supplied to the adhering arm 51 by controlling the seed input unit, so the seeds may accurately and quickly adhere the seeds since the controller 80 drives the adhering arms 51. When the adhering of the seeds is finished, the controller 80 stops the driving of the adhering arms 51 and drives the moving unit 20 again and moves the mulching film 1 until the recognition unit 52 recognizes the identifier 6 adhered to the next row.

In addition, the seed-adhered mulching film 1 moves to the release agent coating unit 60. The release agent coating unit 60 includes a third detection unit 63 configured to recognize the identifier 6 adhered to the mulching film 1 and transmit the detection signal to the controller 80, a release agent storing unit for storing a release agent, a plurality of release agent nozzles 61 which are spaced-apart at the second specific intervals 5 and are configured to spray the release agent stored in the release agent storing unit to the mulching film 1, and a release agent input unit disposed between the release agent nozzles 61 and the release agent storing unit for thereby adjusting the amount of the release agent supplied to the release agent nozzles 61.

In addition, the release agent coating unit 60 includes a fourth interval adjusting unit 62 for thereby adjusting the interval between the release agent nozzles 61. The interval between the release agent nozzles 61 may be adjusted so that the interval between the release agent nozzles 61 may be same as the second specific interval 5 of the mulching film 1 by means of the fourth interval adjusting unit 62.

In addition, the controller 80 controls the amount of the release agent supplied to the release agent nozzles 61 by controlling the release agent input unit. When the third detection unit 63 recognizes the identifier 6 while the mulching film 1 moves by the operation of the moving unit 20, the controller 80, which has received the detection signal, stops the driving of the moving unit 20, and the release agent is supplied to the release agent nozzles 61 by controlling the release agent input unit, and the controller 80 drives the release agent nozzles 61, so that the release agent may be accurately and quickly coated on the portions where the adhesive is coated. When the coating of the release agent is finished, the controller 80 stops the driving of the release agent nozzles 61 and drives the moving unit 20 again and moves the mulching film 1 until the third detection unit 63 recognizes the identifier 6 adhered to the next row.

Finally, the seed-adhered mulching film 1 is wound around the rewinder 70 through the fourth rotation unit 24, the fifth rotation unit 25, the sixth rotation unit 26 and the seventh rotation unit 27 and is stored in a roll shape.

In addition, the table 1 below shows a comparison of the labor time between the typical agriculture method and the seed agriculture method using the mulching film 1 to which the seeds are adhered using the seed adhering device 100 having a blocking prevention function according to an exemplar embodiment of the present invention.

TABLE 1

| | Transplantation | | Seed |
|---|---|---|---|
| | of medium | Direct planting | film-based |
| Agriculture method- | seedling using | on dried | agriculture |
| based work | machine | paddy field | method |
| Stopping plowing | 2.4 | 1.6 | 4.0 |
| Raising | 6.9 | 0.3 | |
| seedling(seeds) | | | |
| Direct(coated) planting | — | 0.7 | 0.1 |
| Transplantation of rice | 3.3 | | |
| seedling | | | |
| Supplemental planting | 1.8 | 1.7 | |
| Spraying of base | 1 | 0.7 | 0.5 |
| fertilizer | | | |
| Spraying of additional | 0.9 | 0.9 | |
| fertilizer | | | |
| Spraying of herbicide | 0.7 | 1 | |
| Labor-used weeding | 2.7 | 4.2 | |
| Control of insects | 2.5 | 2.4 | 2.5 |
| Water management | 3.9 | 3.9 | |
| etc. | | | |
| Harvest | 1.8 | 1.7 | 1.8 |
| Drying | 2.1 | 2.2 | 2.1 |
| Transportation and | 0.7 | 0.6 | 0.7 |
| others | | | |
| Total labor time | 30.7 | 21.9 | 11.6 |

As seen in Table 1, the seedling raising work is not necessary and the spraying of additional fertilizer and weeding work may be omitted when using the seed adhering automation device 100 having a blocking prevention function according to an exemplary embodiment of the present invention, so it is possible to obtain the highest labor cost saving effect as compared with the typical agriculture method.

We claim:

1. An apparatus for automatically adhering seeds to a mulching film, comprising:
an unwinder which is configured to wind the mulching film and store in a roll shape;
a moving means which is configured to move the mulching film wound around the unwinder to a work space;
a punching means which is provided at the work space and forms a plurality of through holes each having a predetermined diameter, on the mulching film which has been moved to the work space or a cutting means which forms a plurality of germination gaps each having a predetermined length, on the mulching film;
an adhesive coating means which is provided at the work space and coats an adhesive on the mulching film which has the germination gaps;
a seed adhering means which is configured to adhere the seeds to a portion where the adhesive is coated by the adhesive coating means;
a release agent coating means which is configured to coat a release agent on the seed-adhered mulching film for thereby eliminating an adhering force of the adhesive;
a rewinder which is configured to wind the seed-adhered mulching film and store in a roll shape; and
a controller which is configured to control the unwinder, the moving means, the cutting means, the adhesive coating means, the seed adhering means, the release agent coating means and the rewinder.

2. The apparatus of claim 1, wherein the release agent is formed of fertilizer, and identifiers spaced apart at a first specific interval in a longitudinal direction are adhered to the mulching film wound around the unwinder, and the identifiers are recognized by a first detection unit provided at the cutting means or the punching means, a second detection unit provided at the adhesive coating means, a recognition unit provided at the seed adhering means and a third detection unit provided at the release agent coating means, and the detection signal is transmitted to the controller, and the controller adjusts a moving speed and a tension of the mulching film by controlling the moving means, and the cutting means or the punching means includes a plurality of cutter knifes and a plurality of laser beam emitting means which are spaced apart at a second specific interval, and a first interval adjusting unit for adjusting the second specific interval, and the adhesive coating means includes a storing unit for storing an adhesive, a plurality of nozzles which are spaced apart at the second specific interval and are configured to spray the adhesive onto the portions where the germination gaps or the through holes are formed, an input unit for supplying the adhesive from the storing unit to the nozzles, and a second interval adjusting unit for adjusting the intervals between the nozzles, and the seed adhering means includes a seed storing unit for storing seeds, a plurality of adhering arms which are spaced apart at a second specific interval and are configured to adhere the seeds to the portions where the adhesive is coated, and a third interval adjusting unit for adjusting the interval between the adhering arms, and the release agent coating means includes a release agent storing unit for storing the release agent, a plurality of release agent nozzles which are spaced apart at the second specific interval and are configured to spray the release agent onto the portions where the adhesive is coated, a release agent input unit for supplying the release agent from the release agent storing unit to the release agent nozzles, and a fourth interval adjusting unit for adjusting the interval between the release agent nozzles.

3. The apparatus of claim 2, wherein the controller stops the driving of the moving means when receiving a detection signal on the identifier detected by the first detection unit and cuts the mulching film by operating and controlling the cutting means, and a plurality of germination gaps spaced apart at a second specific interval are formed on the mulching film in the widthwise direction, and when the detection signal on the identifier detected by the second detection unit is received, the controller stops the driving of the moving means and inputs a predetermined set amount of the adhesive into the nozzles by operating and controlling the input unit and controls the adhesive to be sprayed onto the portions around which the germination gaps are formed by operating and controlling the nozzles, and when the recognition unit receives the detection signal on the identifier, the controller stops the driving of the moving means and adheres the seeds to the portions where the adhesive is coated by controlling the adhering arms.

4. A method for adhering seeds by using the apparatus for automatically adhering seeds to a biodegradable mulching film having an anti-blocking function, comprising:
a step where a mulching film is wound around an unwinder and is stored in a roll shape;
a step where the mulching film wound around the unwinder is moved by a moving means to a work space;
a step where a plurality of germination gaps are formed using a cutting means on the mulching film which has been moved to the work space or a plurality of through holes are formed using a punching means on the mulching film;
a step where an adhesive is coated, using the nozzles of the adhesive coating means, on the portions where the germination gaps or the through holes are formed;
a step where the seeds are adhered, using adhering arms of the seed adhering means, to the portions where the adhesive is coated;
a step where a release agent is coated, using release agent nozzles provided at the release agent coating means, on the portions where the adhesive is coated; and
a step where the seed-adhered mulching film is wound using the rewinder and is stored in a roll shape.

5. The method of claim 4, wherein identifiers spaced apart at first specific intervals in longitudinal directions are adhered to the mulching film, and the forming step includes a step where a first detection unit provided at the cutting means or the punching means detects the identifiers, and the detection signal is transmitted to the controller, and the adhesive coating step includes a step where a second detection unit provided at the adhesive coating means detects the identifiers, and the detection signal is transmitted to the controller, and the seed adhering step includes a step where a recognition unit provided at the seed adhering unit recognizes the identifiers, and the recognized signal is transmitted to the controller, and the release agent coating step includes a step where a third detection unit provided at the release agent coating means detects the identifiers, and the detection signal is transmitted to the controller.

6. The method of claim 5, wherein before the moving step, there is further provided a step where a first interval adjusting unit provided at the cutting means or the punching means adjusts the intervals between a plurality of cutting knifes or a plurality of laser beam emitting means provided at the cutting means or the punching means to the second specific interval, and a second interval adjusting unit provided at the adhesive coating means adjusts the interval between a plurality of nozzles provided at the adhesive coating means to the second specific interval, and a third interval adjusting unit provided at the seed adhering means adjusts the interval between a plurality of adhering arms provided at the seed adhering means to the second specific interval, and a third interval adjusting unit provided at the release agent coating means adjusts the interval of a plurality of release agent nozzles provided at the release agent coating means to the second specific interval, and the germination gap forming step includes a step where when the detection signal on the identifiers detected by the first detection unit is received, the controller stops the driving of the moving means and forms a plurality of germination gaps or a plurality of through holes which are spaced apart at the second specific interval in the widthwise direction of the mulching film by operating and controlling the cutter knifes or laser beam emitting means provided at the cutting means or the punching means, and the adhesive coating step further includes a step where when the detection signal on the identifiers detected by the second detection unit, the controller stops the driving of the moving means and controls for a predetermined set amount of the adhesive to be inputted into the nozzles by operating and controlling the input unit provided at the adhesive coating means and controls for the adhesive to be sprayed onto the portions where the germination gaps are formed by operating and controlling the nozzles, and the seed adhering step further includes a step where when the recognition unit receives the detection signal on the identifiers, the controller stops the driving of the moving means and controls the seeds to be adhered to the portions where the adhesive is coated, by controlling the adhering arms, and the release agent coating step further includes a step where when the detection signal on the identifiers detected by the third detection unit is received, the controller controls for a predetermined set amount of release agent to be inputted into the release agent nozzles by operating and controlling the release agent input unit provided at the release agent coating means, and controls for the release agent to be sprayed onto the portions where the adhesive is coated, by operating and controlling the release agent nozzles.
